(19) United States
(12) Patent Application Publication
(10) Pub. No.: US 2019/0334759 A1
(43) Pub. Date: Oct. 31, 2019

(54) UNSUPERVISED ANOMALY DETECTION FOR IDENTIFYING ANOMALIES IN DATA

(71) Applicant: Microsoft Technology Licensing, LLC, Redmond, WA (US)

(72) Inventors: Amrita Ray, Redmond, WA (US); Ross Faulkner Smith, JR., Eastbound, WA (US); Neil B. Ozzie, Seattle, WA (US); Ting Wei Lee, Redmond, WA (US); Xin Deng, Redmond, WA (US)

(21) Appl. No.: 15/963,865

(22) Filed: Apr. 26, 2018

(51) Int. Cl. H04L 12/24; G06F 11/07; G06F 17/18; H04L 12/26

(52) U.S. Cl. CPC H04L 41/064; H04L 41/065; H04L 43/062; G06F 17/18; H04L 43/04; G06F 11/0709

(57) ABSTRACT

Disclosed in some examples are technical solutions to the existing technical problems in computer-implemented identification of anomalous events for distributed unstructured data existing in current supervised and unsupervised approaches. The anomaly detection system may use one or more unsupervised approaches that factor in small data sets using a volume-based time-invariant model. In some examples, in addition, a cross-category proportionality based model may also be utilized.

### BACKGROUND

As computer technology has grown, so too has the amount of data produced by this technology. Applications such as microblogging services, social networking services, email, text messages, websites, customer relations managers, and others create large volumes of data daily. The volume of this data is so great that no human workforce can keep up and read every comment, understand the context of every conversation, or flag something notable in the stream of text data. This is especially true in instances in which the anomaly detection needs to be done very fast. For example, detecting anomalies in financial data from financial news sources to execute a stock order, ensure market rules are followed, monitoring high frequency trading, and the like may need to be done within milliseconds—much too fast for a human.

When this data is unstructured (e.g., it does not follow a structure or pattern), processing this large volume of data to quickly find anomalies is impossible to do manually and presents a complex technological problem in computer science to do automatically. As a result, automated ways of finding anomalies and other items of interest have become a topic of study and consideration.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example environment of an anomaly detection system according to some examples of the present disclosure.

FIG. 2 illustrates a schematic data flow of data packets through a computing device of anomaly detection system according to some examples of the present disclosure.

FIG. 3 shows a flowchart of one example method applied to determine whether a particular category is anomalous according to some examples of the present disclosure.

FIG. 4 illustrates a schematic data flow of a volume-based time invariant modeler according to some examples of the present disclosure.

FIG. 5 illustrates a schematic data flow of a cross-category proportionality modeler according to some examples of the present disclosure.

FIG. 6 illustrates a flowchart of a method for anomaly detection in distributed, unstructured data, according to some examples of the present disclosure.

FIG. 7 illustrates a usage environment of an anomaly detection system according to some examples of the present disclosure.

FIG. 8 illustrates another usage environment of an anomaly detection system according to some examples of the present disclosure.

FIG. 9 is a block diagram illustrating an example of a machine upon which one or more embodiments may be implemented according to some examples of the present disclosure.

### DETAILED DESCRIPTION

Detection of anomalies in unstructured data is an important technical challenge for artificial intelligence researchers. Example usages of anomaly detection in unstructured data include software bugs detected from user feedback reports, trending topics from micro blogs such as Twitter, monitoring of voluminous electronic communications (e.g., instant messaging and email) to detect targeted events, abnormalities in network traffic, malfunctions in computer systems utilizing logs, processing financial information, processing sensor data for Internet of Things (IoT) devices, and the like.

Current approaches for automated processing of anomalies may employ supervised learning that requires large training data sets that have data that is manually labeled by humans as being anomalous or not-anomalous. Supervised learning solutions are costly and time consuming to produce as they require a source of training data and typically a human to label the anomalies. The accuracy of supervised learning models depends on the quality of training data and the quality of the labelling of the training data. Because anomaly detection algorithms must identify events significantly different from that observed normally, it is unlikely that there will be corresponding training data. Thus, supervised approaches do not tend to detect anomalies well. In addition, even with accurate training data that produces a model that is initially accurate, the model may not adapt over time to changing conventions and language of users. Thus, the accuracy of these solutions may suffer over time without periodic retraining. In addition, in rapidly changing social media environments, user shifts to new platforms or new formats present problems that require a new model. Training and retraining the system also may be time consuming and costly.

Unsupervised approaches do not have the same issues with anomalies that supervised approaches have because unsupervised approaches are more flexible as they do not rely upon training data. For example, events can be compared with other existing events, and existing events can be compared with their historical data to detect anomalous data. These unsupervised approaches have proven useful for real life applications, especially for applications with fast/ever changing data. Examples include social channels with large volumes of data and/or applications where new events can occur very frequently. For example, new topics in Twitter, new pages in Facebook, changing usage habits, changing scenarios on the road for self-driving cars, and the like.

Current unsupervised approaches that do not require the data to be labeled have tended to detect anomalies that produce large amounts of data, but do not typically work well at finding anomalies that generate more limited amounts of data. For example, current unsupervised approaches may first categorize the data and then flag categories that experience the greatest volume. This is problematic in that a serious anomaly that is seen only a few times in the data set may be obscured by other categories that generates large amounts of data and are less interesting.

For example, one application of event detection is processing customer feedback from a software application. Customers may have a large amount of regular complaints that are not indicative of a software fault but instead may be related to a fault in their configuration or network condition. These frequent complaints that are not interesting may mask an actual bug report that is not reported by enough users to be noticed using prior art unsupervised systems.

Other types of unsupervised approaches also are incapable of learning from past data. For example, the unsupervised approaches often utilize statistics calculated from the volume of data and threshold values. These statistics are typically inflexible and do not respond well to changes in the source data.

Disclosed in some examples are technical solutions to the existing technical problems in identification of anomalous events existing in current supervised and unsupervised approaches. In an example, an anomaly detection system may use one or more unsupervised approaches that work on small data sets using a volume-based time-invariant model and in some examples a cross-category proportionality model. The anomaly detection system may first partition the data packets into a plurality of predetermined topics. Next, the number of packets assigned to a particular category may be counted. The system then utilizes the average number of data packets assigned to the particular category that were observed in a past time window to predict how likely the currently observed count of the number of data packets in the particular category is. This probability may be utilized to determine if an anomaly is present in the data packets assigned to the category (e.g., by comparing it to a threshold). In some examples, the volume-based time invariant model probability may be calculated using a time-invariant Poisson distribution.

Thus, if a present volume of feedback for a category is significantly higher given a past average volume of data packets assigned to the category, then the system may conclude that the category is anomalous (as the probability of such a volume of data packets assigned to that category would be low). The volume-based time-invariant model allows the anomaly detection system to recognize low-volume anomalies in high volume datasets. Note that the Poisson distribution herein may be a time invariant Poisson that does not adjust for time of day and day of the week adaptations.

Once an anomaly is detected, the information that the category is anomalous may be utilized to explore the data packets in the category to determine whether there is an anomalous event that needs attention. In various examples, the system may utilize automated operations to respond to the anomaly, such as rebooting a computing device, updating software on the computing device, initiating a communication to a user describing the anomaly or an indication that an anomaly was found (e.g., such as sending a short message service (SMS) message), and the like.

In some examples, large shifts in volume of all categories in a particular timeframe may trigger problems by using only the volume-based time invariant model. To address this issue, in some examples, in addition to utilizing the volume-based time invariant model, a cross-category proportionality model may also be utilized. The cross-category proportionality model detects significant changes in the proportion of packets assigned to the particular category out of the total packet count in comparison with its usual proportion count or trend. This ensures that large changes in all data in the set do not skew the results. The cross-category proportionality model may be an unsupervised model. In some examples, the cross-category proportionality model may be based upon a Gaussian probability model.

The disclosed technical solutions employing the volume-based time-invariant and/or cross-category proportionality models improve on unsupervised approaches to solve the technical challenges of detecting anomalies in unstructured data. These technical approaches do not require expensive and inflexible training approaches utilized by supervised machine learning approaches and at the same time avoid the problems with low-volume data that current unsupervised models suffer from. The present solutions are computationally fast enough to produce results in applications requiring speedy computations, and flexible enough to adapt to changing data patterns over time. These solutions improve the functioning of the computer by providing solutions that are more accurate at detecting anomalies than current unsupervised solutions, resulting in reduced processing power and computing resource usage, while still providing more functionality than conventional supervised solutions.

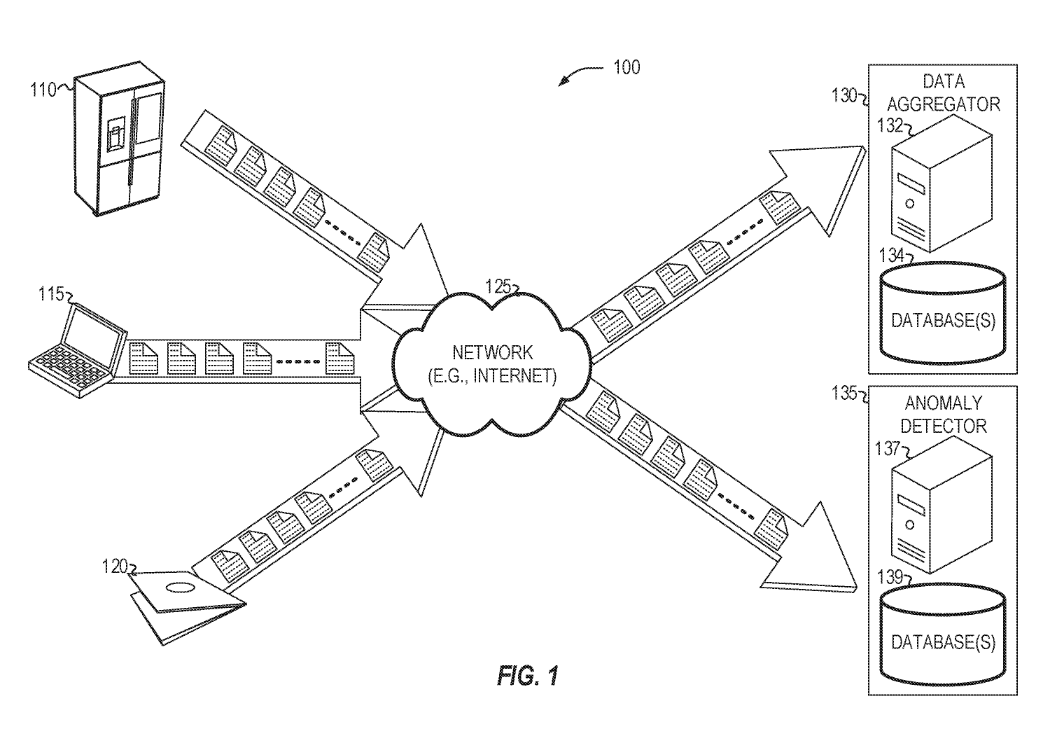

FIG. 1 shows an example environment 100 of an anomaly detection system 135 according to some examples of the present disclosure. Example data sources for input data packets to the anomaly detection system 135 are shown in FIG. 1 sending data packets across network 125 to a data aggregator 130. As shown in FIG. 1, data sources include an Internet of Things (IoT) device 110 (as shown, a smart refrigerator), a first computing device 115 and a second computing device 120. While laptops and refrigerators are shown in FIG. 1, other data sources may include smart thermostats, smart sensors, desktops, smartphones, server computers, content sites, media sites, car infotainment systems, network routers, and the like. Data packets sent by the data sources may be short messages (e.g., TWEETS®), email messages, news articles, text messages, software feedback, IoT sensor data, position data, packet data, and the like.

Network 125 may be, or include, a Wide Area Network (WAN), Local Area Network (LAN), Metropolitan Area Network (MAN), the internet, intranet, or the like. Network 125 may be a packet-based network.

Data sent by the data sources of FIG. 1, including the IoT device 110, first computing device 115 and second computing device 120 may be sent to the data aggregator 130. Data aggregator may receive the data packets, e.g., using computing device 132, process it, and store it in database 134. In some examples, computing device 132 may provide the data to other devices or utilize the data to provide one or more services. Examples of such services may include microblogging services, email servers, IoT device managers, cloud application services, social networking services, application programming interfaces (APIs), and the like. For example, the data aggregator 130 may be a social networking service, a microblogging service, an IoT management platform, a stock trading platform, a news platform, or the like.

Anomaly detection system 135 may comprise one or more computing devices, data storage (e.g., databases) devices, and the like. For example, anomaly detection system 135, as shown in FIG. 1, includes a computing device 137 and a database 139. The anomaly detection system 135 may request and receive data packets from the data aggregator 130; process them; and detect one or more anomalous data packets. In some examples, an anomaly is a determined characteristic of a computing device that is observable by information in the data packets. The determined characteristic may be determined based upon the context in which the anomaly detection system 135 is utilized. For example, a software error (e.g., a bug) may be observable by comments left by users in feedback data. While the anomaly detection system 135 is shown as a separate system from data aggregator 130, in other examples, the anomaly detection system 135 may be a part of the data aggregator 130. Thus, in some examples, the data sent by data sources may be sent directly to the anomaly detector, rather than being sent first to the data aggregator 130.

In some examples, computing devices 115, 120, and IoT device 110 may execute one or more computing applications that may have interfaces, such as a graphical user interface (GUI) that allows users to submit feedback to the developers of the application. This feedback may be sent to the data aggregator 130 where computing device 132 may store the feedback in the database 134. In these examples, anomaly detection system 135 may look for bugs to surface to the development team using one or more of the time-invariant model and/or the proportionality model.

In some examples, computing devices 115, 120, and/or IoT device 110 may provide operational data such as computing logs (e.g., showing faults in hardware or software) and sensor data (e.g., from hardware sensors of the device) for monitoring and/or debugging purposes for one or more applications or hardware devices to the data aggregator 130. This operational data may be sent to the data aggregator 130 where computing device 132 may store the operational data in the database 134. In these examples, anomaly detection system 135 may look for hardware or software bugs in these logs to surface to the development team or to technical support personnel.

In some examples, a plurality of geographically distributed IoT devices (such as IoT device 110) may provide sensor data (e.g., from hardware sensors of the device) to the data aggregator 130. For example, a network of temperature sensors may monitor temperatures of a plurality of different locations. This sensor data may be sent to the data aggregator 130 where computing device 132 may store the sensor data in the database 134. In these examples, anomaly detection system 135 may look for sensor data anomalies in these logs to surface to a user.

In some examples, computing devices 115, 120, and/or IoT device 110 may provide communications messages to data aggregator 130. Example communications messages may include status updates, microblogging messages (e.g., TWEETS®), chat messages, VoIP messages, text messages, email messages, video messages, and the like. These computing devices 115, 120, and/or IoT device 110 may provide one or more GUIs for entering these communications. For example, data aggregator 130 may provide a microblogging service, email service, VoIP connectivity, text message connectivity and the like. In these examples, anomaly detection system 135 may look for trending topics or categories of communications that are of interest to surface to a user using one or more of the time-invariant model and/or the proportionality model.

In some examples, data aggregator 130 may not be the intended recipient of the data generated by the computing devices 115, 120, and IoT device 110. For example, data aggregator 130 may be a network infrastructure component (e.g., a router, switch, hub, network monitor, or the like) that may monitor network traffic for the network 125 or for a portion of network 125. In these examples, anomaly detection system 135 may look for suspicious network traffic to surface to a network security user using one or more of the time-invariant model and/or the proportionality model.

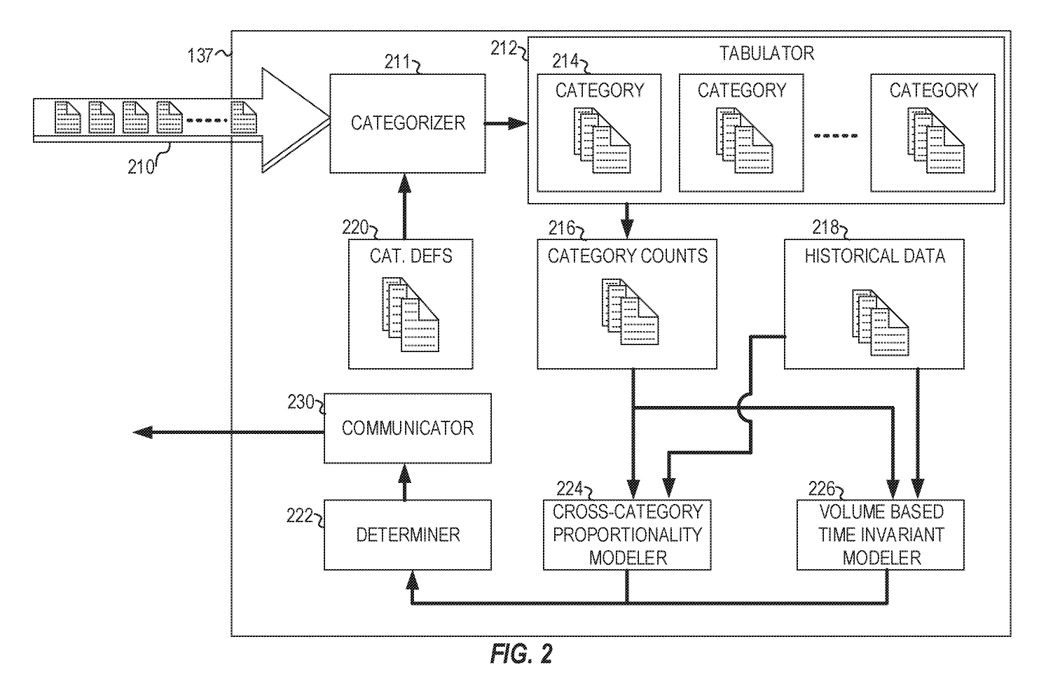

FIG. 2 illustrates a schematic data flow of data packets through a computing device 137 of anomaly detection system 135 according to some examples of the present disclosure. Data packets 210 may have originated from one or more distributed computing devices such as end-user computing devices, laptops, desktops, tablets, IoT devices, servers, routers, network switches, and the like. In some examples, data packets 210 may have originated from a single computing device. In some examples, the data may be obtained from a data aggregator, such as data aggregator 130. The data packets 210 may have been modified by data aggregator, nevertheless, the data packets 210 may be said to have originated from a plurality of distributed computing devices. Example data packets 210 may include feedback submitted by users from and about applications executing on the user's computing devices. For example, users may submit feedback about the call quality of a communication session. In other examples, data about the communication session such as Quality of Service (QoS) data, packet loss, jitter information, and the like may be considered feedback and input into the anomaly detection system. In other examples, data packets may include messages for social networking services, microblogging services (e.g., TWEETS® for TWITTER®), network traffic data, IoT sensor data, financial data, financial news, and the like.

Data packets 210 may comprise one or more computer representations of data and may be stored and transmitted as a data structure, or the like. The term data packet may refer to a packetized data that is transmitted over a packet-based network, or more generally may refer to data encapsulated in a data object or a data structure. In some examples, the anomaly detection system 135 may receive data packets 210 (e.g., from data aggregator 130) and these data packets 210 may be batched—that is, a group may arrive at the same time or may arrive shortly after they are generated. In some examples, if the data packets 210 arrive shortly after they are generated they may be temporarily stored until a large enough amount of data is collected. In some examples, the anomaly detection system 135 may operate on data generated during a predetermined time window. For example, the anomaly detector may detect anomalies in data generated within a particular second, minute, hour, day, week, month, year, and the like.

Data packets 210 may be input into a categorizer 211. Categorizer 211 may apply one or more category definitions 220 to categorize the data packets 210 into one or more of a plurality of determined categories 214. Category definitions 220 may specify one or more conditions that, when satisfied, indicate that a data packet is to be categorized in a particular category. For example, the data packets 210 may have one or more structured or unstructured components whose value may be utilized for categorization. In the case of application feedback, the data packets 210 may have one or more fields that have a limited set of valid values. For example, the data packets may specify a platform the application was executing on, the user may be asked to select a category of issue, and the like. In other examples, the feedback may be a free-text format. In other cases, such as messages posted to microblogging services, the data packets may include meta-data, but may otherwise be unstructured in that, while the data type may be defined (e.g., a string, a number, or the like) and the size (e.g., 140 characters)—the actual contents of the data may not be restricted to a particular set of valid values.

Categorizer 211 may categorize the data according to structured or unstructured portions of the data packets 210 based upon criteria in the category definitions 220. For example, category definitions 220 may include a field, a value, and a category. If the field in a given data packet matches the value, it is assigned to the particular category. In some examples, the category definitions 220 may comprise one or more keywords. If the data packet contains one or more of the keywords corresponding to a particular category, the data packet may be assigned to that category. In some examples, each data packet may be assigned to a single category. In other examples, each data packet may be assigned to more than one category. This may be desirable in that the data may describe more than one software bug, more than one topic, more than one sensor reading, and the like. The categorizer 211 may add information about the assigned one or more categories to metadata about each data packet. In some examples, each data packet may be numbered or otherwise labeled with a unique identifier—in these examples, the categorizer may simply note which identifiers are assigned to which categories. In some examples, rather than tracking which packets were assigned to which particular categories, the categorizer 211 and the tabulator 212 may simply count the number of packets assigned to each category.

Tabulator 212 may determine from the data packets in the category groups 214 a count of the number of data packets in each category. In some examples, the tabulator 212 may count the number of data packets after the packets have been assigned to categories. In other examples, the tabulator 212 works alongside categorizer 211 such that each time a data packet is processed and assigned a particular category by the categorizer 211 the count for the particular category is incremented. These category counts 216, along with historical data 218 may then be input to one or both volume-based time invariant modeler 226 and the cross-category proportionality modeler 224.

In some examples, the volume-based time-invariant modeler 226 may calculate, for one or more categories, a probability of occurrence of the volume of data packets assigned to that category for the current time window given a running average count for past time windows stored in historical data 218. For example, the volume-based time invariant modeler 226 may calculate the probability according to a Poisson distribution:

$$P ( X = x ) = \frac{{λ}^{x} {e}^{- λ}}{x !}$$

where x is the volume of data packets assigned to the category for the particular time window and λ is the central tendency (e.g., average) of the count of data packets observed in a given past time window. Thus, the volume-based time invariant modeler calculates a post-hoc probability of occurrence of the volume of data packets assigned to the category based upon historical average amounts of data packets in the category. Categories with low probabilities may be labeled as anomalous. The time-invariant aspect recognizes that the probability of the volume of data packets in a category being a particular value is not dependent on past time windows. In addition, the time-invariant aspect does not differentiate between time of day, day of the week, and the like. The output of the volume-based time invariant modeler 226 may be the calculated probability.

In some examples, the historical data 218 and the category counts 216 may be input to a cross-category proportionality modeler 224. The cross-category proportionality modeler 224 may flag significant changes in a proportion of the count of data packets assigned to a particular category out of the total count of data packets in the current time window in comparison with the particular category's usual proportion pattern or trend in a previous time window (e.g., the average proportion or other central tendency). For example, the proportion Z for a category a may be given by:

$${Z}_{a} = \frac{{V}_{a}}{sum ( {\sum }_{0}^{i} {v}_{i} )}$$

Where i is the set of categories, νᵢ is the volume of data assigned to category i and a is a member of i.

This cross-category proportionality modeler 224 may utilize a Gaussian distribution to determine a probability for this proportion given a usual proportion pattern or trend for a past time period. In some examples, the probability may be calculated as

$$f ( x \vert μ , {σ}^{2} ) = \frac{1}{\sqrt{2 π {σ}^{2}}} {e}^{- \frac{{( x - μ )}^{2}}{2 {σ}^{2}}}$$

Where μ is the mean proportion in a past time window, and σ is the standard deviation. The output of the cross-category proportionality modeler 224 may be the calculated probability.

While a Gaussian distribution was utilized to calculate a probability, other proportionality models may be utilized. For example, a deviance in proportion from a median proportion that is over a threshold for a particular category may also trigger a determination that the particular category is, or may be, anomalous.

The outputted probabilities of the cross-category proportionality modeler 224 and the volume-based time invariant modeler 226 may be processed by determiner 222. If a single model is utilized, then that model's output may be compared to a threshold. For example, if the probability is below a threshold, then the probability may be said to be rare and the category anomalous. If multiple models are utilized, if the probability of the volume-based time invariant model is below a first threshold and the probability of the cross-category proportionality model is below a second threshold (which may be the same or different than the first threshold) then both models indicate a category is anomalous and the category may be marked anomalous. Likewise, if only one model's probability is below the respective threshold, the category may not be marked as anomalous. In other examples, other formulas may be utilized. For example, the probability from the volume-based time invariant model may be weighted and combined with a weighted probability of the cross-category proportionality model and if the result is above or below a threshold, the category may be marked anomalous. Combining the weighted probabilities may include multiplication, division, addition, or subtraction.

A list of one or more anomalous categories may be provided to the communicator 230 for communicating the list to one or more persons. Communicator 230 may create one or more GUI descriptors that may be available (e.g., made available using a server) through one or more protocols (such as HyperText Transfer Protocol (HTTP) and associated lower level protocols). GUI descriptors may include one or more HyperText Markup Language (HTML), eXtensible Markup Language (XML), Cascading Style Sheet (CSS), scripting documents, and the like. In other examples, the communicator 230 may send an email, a text message, a voice message, may send an instant message, may establish a VoIP session, or the like. In other examples, the anomaly detector may perform one or more automatic operations to address the anomaly (as will be explained in more detail below).

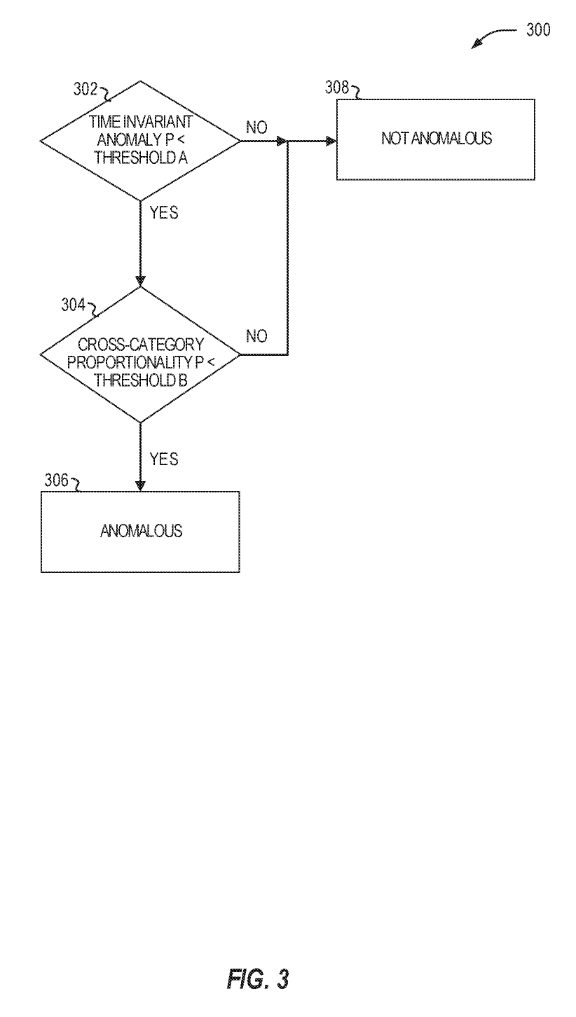

FIG. 3 shows a flowchart 300 of one example method applied by determiner to determine whether a particular category is anomalous based upon both the volume-based time invariant model and the cross-category proportionality model according to some examples of the present disclosure. At operation 302 a determination may be made if the probability (P) output by the volume-based time invariant model is below a first threshold (marked threshold A in the figure). If the answer is NO, then the category is labeled as not anomalous at operation 308. If the answer is YES, then the system may determine at operation 304, whether the probability returned by the cross-category proportionality is less than a second threshold (marked threshold B in the figure). If the answer is YES, then the category is marked as anomalous at 306. If the answer is NO then the category is marked as not anomalous at 308.

In some examples, the category may not be evaluated under the cross-category proportionality model unless the result of the determination at operation 302 is YES. In some examples, the cross-category proportionality model is evaluated first and the volume-based time invariant model is only evaluated for a category if the cross-category proportionality model finds the category anomalous.

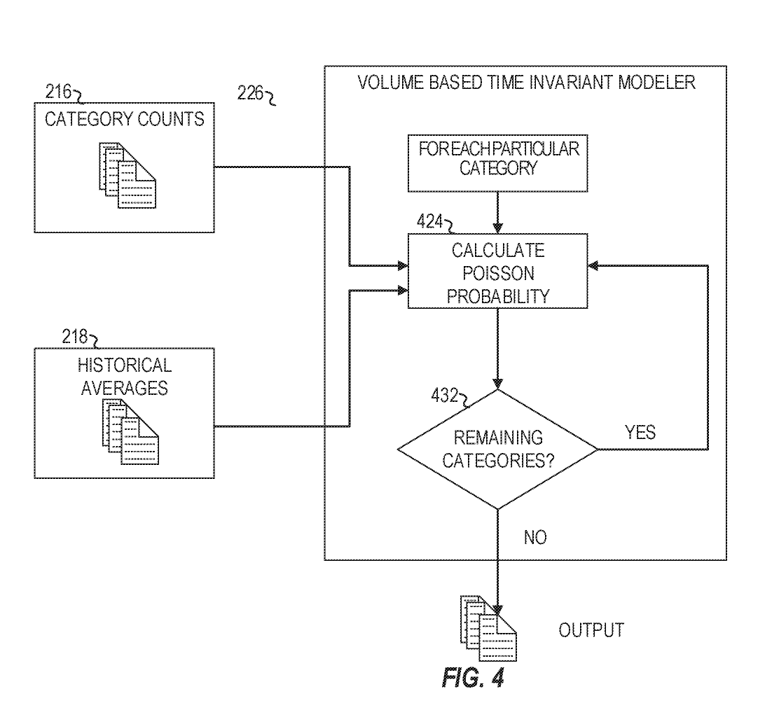

FIG. 4 illustrates a schematic data flow of a volume-based time invariant modeler 226 according to some examples of the present disclosure. Volume-based time invariant modeler 226 may decide or factor into the decision of whether one or more categories are anomalous. For each particular category, at operation 424 the volume-based time invariant modeler 226 may utilize the category count from category counts 216 and the historical average from the historical data 218 corresponding to the particular category to calculate a probability. The probability may be calculated using a Poisson distribution that calculates, based upon the average number of data packets allocated to a particular category in past time windows, how likely the current number of data packets being allocated to the particular category was. At operation 432, if there are any remaining categories to calculate, then operation proceeds back to operation 424 where the next category is processed. If there are no more categories, then the calculated probabilities may be output.

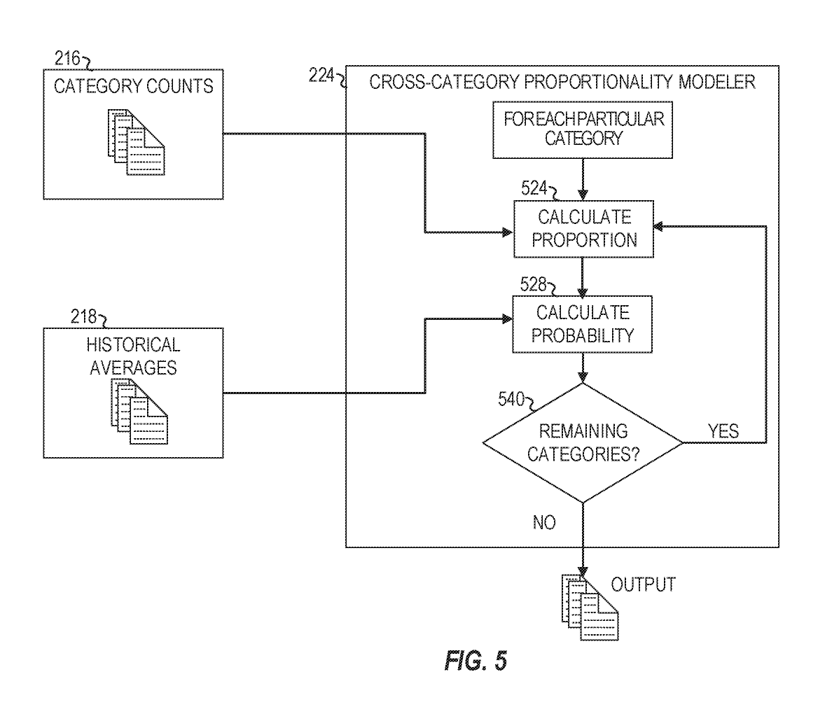

FIG. 5 illustrates a schematic data flow of a cross-category proportionality modeler 224 according to some examples of the present disclosure. Cross-category proportionality modeler 224 may decide or factor into the decision of whether one or more categories are anomalous. For each particular category, at operation 524 the cross-category proportionality modeler 224 may calculate a proportion of the total number of data packets that were assigned to the particular category. At operation 528, based upon the proportion and the historical average proportion of the category obtained from the historical data 218 the cross-category proportionality modeler 224 may calculate a probability of how likely the category would increase or decrease in proportion as compared with the average proportion over a predetermined time window. The cross-category proportionality modeler 224 flags categories as potentially anomalous that have significant changes in its volume proportion out of the total volume in the current week in comparison with its usual proportional pattern or trend over a predetermined time period. For example, by utilizing a Gaussian distribution.

At determination operation 540, if there are any remaining categories to check, then operation proceeds back to operation 524 where the next category is processed. If there are no more categories, then the calculated probabilities may be output from the proportionality modeler.

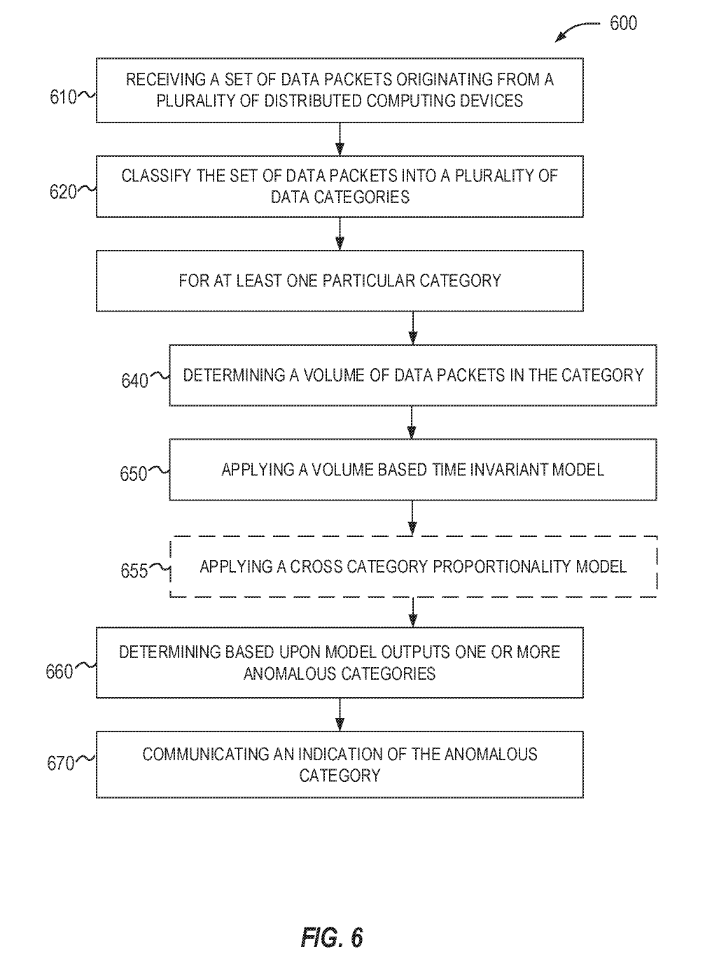

FIG. 6 illustrates a flowchart of a method 600 for anomaly detection in distributed, unstructured data, according to some examples of the present disclosure. At operation 610 the anomaly detection system may receive a set of data packets originating from a plurality of distributed computing devices. In some examples, this may be accomplished by sending a request to a data aggregator or other service and receiving the data in response. The request and response may be according to an API specified by the data aggregator and may be over a packet-based digital communications network and in accordance with one or more standard communication protocols such as Internet Protocol (IP), Transmission Control Protocol (TCP), User Datagram Protocol (UDP), HyperText Transfer Protocol (HTTP), and the like. In other examples, the distributed computing devices may send the data packets to the anomaly detection system directly. The data packets may be in any format of form, for example, the data packets may have a header and one or more unstructured or structured data fields. The header may define a packet length. The set of data packets may be for a predetermined time window.

At operation 620 the system may classify the set of data packets into a plurality of categories. In some examples, the system may have category definitions that may comprise a set of one or more keywords that correspond to the plurality of categories. If the data in the data packets matches one or more of the keywords, then that data packet is assigned to the category. In some examples, the data packet may be assigned to multiple categories (e.g., by matching multiple keywords from multiple categories). In still other examples, a data packet may only be matched to a single category. For example, the category in which the data in the data packets may match the most keywords associated with that category.

At operation 640, for a particular category the volume of data packets in the particular category may be determined. For example, a list of the data packets in a particular category may be maintained. The system may count the number of data packets in the particular category by looping through the set of all data packets and adding one to a running total for each data packet assigned to the category. In other examples, at operation 620, a running total for each category may be kept, and when a particular data packet is added to a particular category, a count for the category may be incremented. In these examples then, the operations of 640 may be to access the memory location in which these counts are stored and determine the value for the particular category using the stored counts.

At operation 650, the category count and the historical central tendency count may be applied as inputs to a time invariant model. In one example, the time invariant model may be a Poisson distribution as described in the formula above. The central tendency may be an average, a median, a mean, or the like. The Poisson distribution may output a probability that the count would have been seen given the central tendency.

At operation 655, in some examples, the system may apply a cross category proportionality model. For example, by calculating a proportion of the volume of data packets assigned to the category as compared to the total volume of the data packets as a whole. The proportion may then be compared with an average (or other central tendency) proportion for a past time period. The cross-category proportionality model may be a gaussian distribution, as previously described. The Gaussian distribution may output a probability that the count would have been seen given the central tendency. In FIG. 6, the cross-category proportionality model was listed as optional and may not be used (as indicated by the dashed lines), but in other examples, the cross category proportionality model may be utilized and the volume-based time invariant model may be optional (or not used).

At operation 660, the system may determine, based upon the model outputs, one or more anomalous categories. If a single model is utilized, then that model's output may be compared to a threshold. For example, if the probability is below a threshold, then the probability may be said to be rare and the category anomalous. If multiple models are utilized, then consistent with FIG. 3, if the probability of the volume-based time invariant model is below a first threshold and the probability of the cross-category proportionality model is below a second threshold (which may be the same or different than the first threshold) then both models indicate a category is anomalous and the category may be marked anomalous. Likewise, if only one model's probability is below the respective threshold, the category may not be marked as anomalous. In other examples, other formulas may be utilized. For example, the probability from the volume-based time invariant model may be weighted and combined with a weighted probability of the cross category proportionality model and if the sum is above or below a threshold, the category may be marked anomalous. Combining the weighted probabilities may include multiplication, division, addition, or subtraction.

Additionally, as noted, operations 650 and 655 may be performed in any order and in some examples in parallel. In some examples, in order to save machine resources, increase computing speed and reduce computing resources, only one of the models is run if the other of the models indicates a probability that would be lower than the threshold probability for that model.

At operation 670, if there are anomalous categories, this information may be communicated to one or more users. For example, by forming an electronic communication such as an email message, text message, or the like and transmitting it to an email server for delivery to one or more predetermined addresses. In other examples, the anomaly detection server may establish an instant messaging session with another user using an instant messaging protocol, such as a SKYPE® protocol, a Session Initiation Protocol for Instant Messaging (SIMPLE) protocol, or the like. As noted below, in addition to communicating the indication, the anomaly detection system may take one or more actions to rectify the anomaly.

Anomalies may be detected in many different types of data in addition to text data such as microblogging posts or application feedback data. For example, facial recognition features, heart rates, voice inflection, pulse, biometrics, cognitive and physical measures, images, and the like. For example, the data packets received at operation 610 may contain or represent any type of data. Examples may include image data, hear rate data, facial recognition data, voice data, biometric data, and the like. At operation 620 the data may be classified into categories using category definitions and/or various algorithms. For example, images may be processed to determine objects and/or meanings of the image and a category of what is displayed in or conveyed by the image may be utilized to classify the image. Heart rates may be classified into resting heart rates, exercise heart rate, and the like. Voice data may be classified based upon a detected emotion, and the like. Operations 640-670 would then proceed as normal, looking for anomalous data.

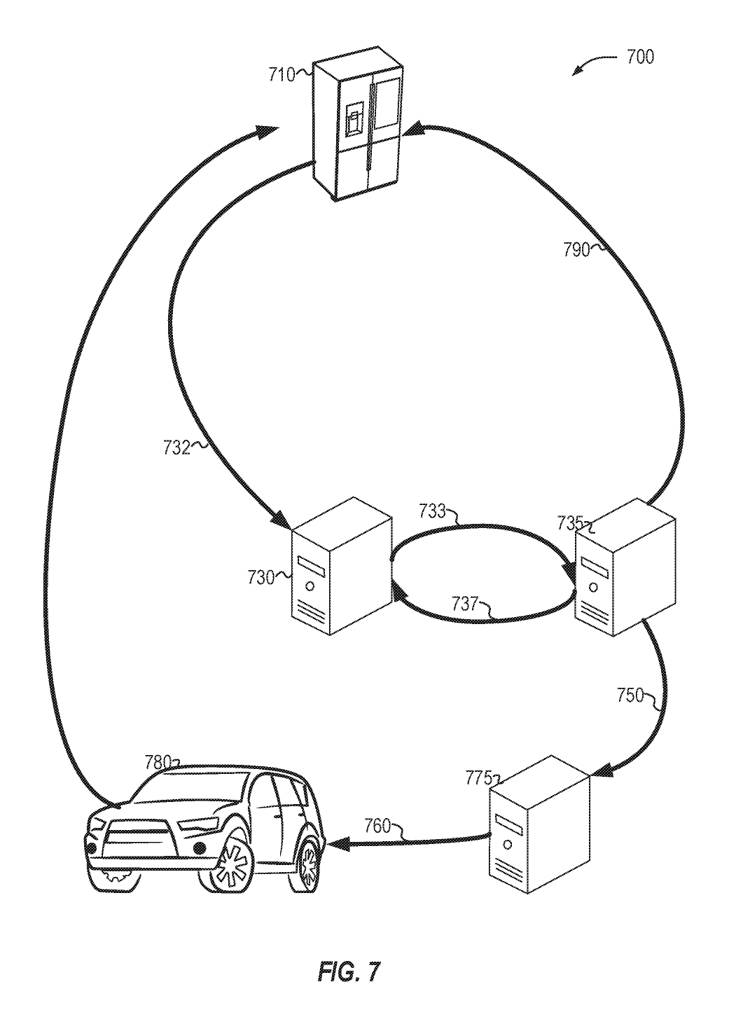

FIG. 7 illustrates a usage environment 700 of an anomaly detection system 735 according to some examples of the present disclosure. Computing device 710 (e.g., an IoT device) may send data packets with sensor data using messaging 732 to a data aggregator 730. Data aggregator 730 may be a management service tasked with monitoring and administering one more devices (e.g., IoT devices) including computing device 710. This data may be obtained by anomaly detection system 735 using messaging 733. Anomaly detection system 735 may be an example of anomaly detection system 135 of FIG. 1. As described earlier, the anomaly detection system 735 may categorize the data packets and may determine one or more anomalous categories. The anomalous categories may be sent back to the data aggregator 730 using messaging 737.

In addition to communicating the anomalous categories to the data aggregator (or other computing device), the anomaly detection system 735 may act on the anomalies. For example, the anomaly detection system 735 may have a table with anomalous categories and actions. For example, if a first category is determined as anomalous, then the anomaly detection system 735 may take a specific action. Example actions may include rebooting the computing device 710, updating the firmware or other software on computing device 710, disabling certain functionality, and the like. The anomaly detection system 735 may signal one or more commands to the computing device 710 through message 790. In other examples, other actions may include automatically messaging a repair service 775 using messaging 750. Repair service 775 may dispatch a repair entity 780 such as a person or automated agent using messaging 760. Repair entity 780 may travel to the computing device 710 and repair it.

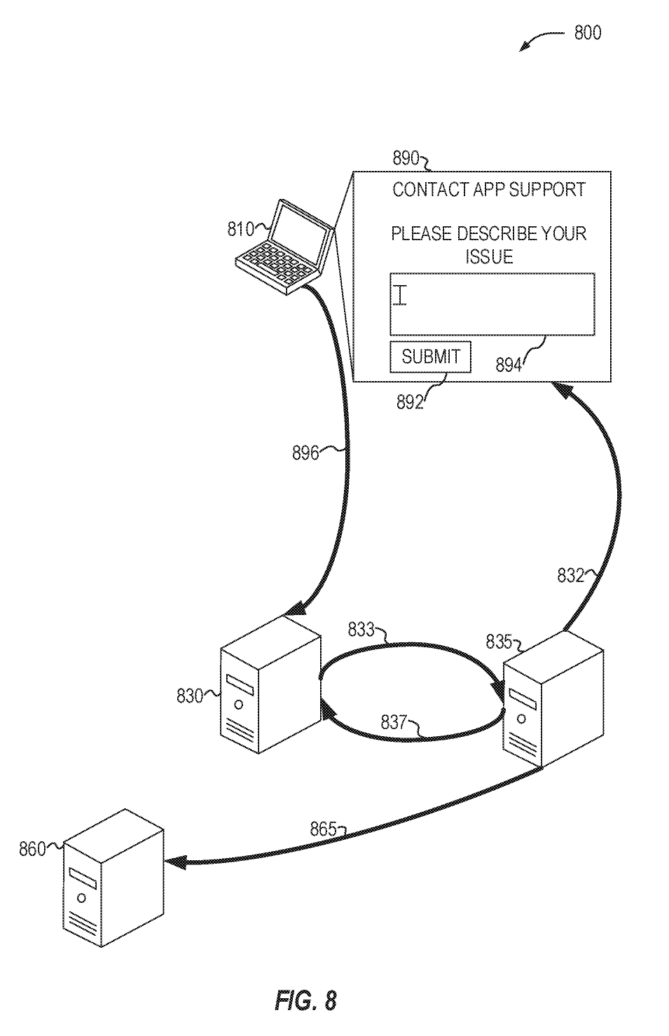

FIG. 8 illustrates a usage environment 800 of an anomaly detection system 835 according to some examples of the present disclosure. Computing device 810 (e.g., a desktop computing device) may provide a GUI 890 allowing a user to submit one or more feedback requests. The GUI 890 may be provided by an application locally, or may be served as one or more GUI descriptors by a web server such as may be provided by data aggregator 830. The user may click the “submit” button 892 and the feedback entered into the text box 894 may be sent as a data packet 896 to the data aggregator 830. Data aggregator 830 may receive and store this feedback. The feedback data packets from computing device 810 and other devices may be obtained by anomaly detection system 835 using messaging 833. Anomaly detection system 835 may be an example of anomaly detection system 135 of FIG. 1. As described earlier, the anomaly detection system 835 may categorize the data packets from messaging 833 and may determine one or more anomalous categories. These categories may be sent back to the data aggregator 830, using messaging 837. In other examples, the anomalous categories may be sent to other services or applications.

The anomaly detection system 835 may act (either automatically or manually) on this information to alert a user or otherwise correct the anomaly. For example, the anomaly detection system 835 may have a table with anomalous categories and associated troubleshooting actions. For example, if a first category is determined as anomalous, then the anomaly detection system 835 may take a specific action indicated by the table for that category. These actions may be signaled to the computing device 810 using messaging 832. Example actions may include updating the application on the computing device 810, changing settings of the application on the computing device 810, rebooting the computing device 810, starting a troubleshooter (e.g., a wizard) on the computing device, updating the firmware or other software on computing device 810, disabling certain functionality, and the like. For example, if the application is a Voice over IP (VoIP) application and the user is complaining about choppy video, the anomaly detection system 835 may lower a video or audio quality setting to improve the quality. In other examples, the anomaly detection system 835 may send one or more messages 865 to a code defect management system 860 to automatically open an issue for tracking and fixing. The anomaly detection system 835 may utilize an API of the code defect management system 860 to communicate with and submit an issue for tracking and fixing. Example code defect management systems may include ClearQuest®, BugZilla, Mantis Bug Tracker®, and the like.

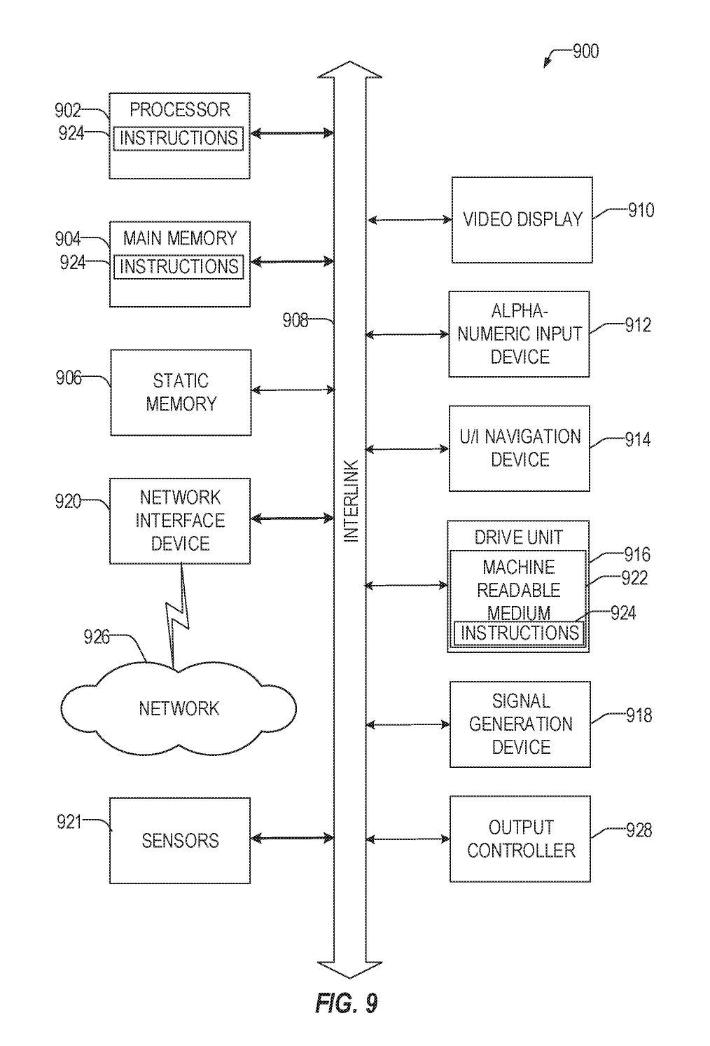

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a data source (such as an IoT device 110); first computing device 115; second computing device 120; computing device 710; computing device 810 data aggregators 130 (including computing device 132, database 134), 730, 830; anomaly detection system 135 (including computing device 137, database 139), 735, 835; repair service 775; code defect management system 860; personal computer (PC); a tablet PC; a set-top box (STB); a personal digital assistant (PDA); a mobile telephone; a smart phone; a web appliance; a network router; switch or bridge; or any machine capable of executing instructions (sequential or otherwise) that specify actions to be taken by that machine. Machine 900 may include the components of FIGS. 2, 4, and 5 (including implementing the data flows shown), and perform the methods of FIGS. 3-6. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). For example, the categorizer 211, tabulator 212, cross-category proportionality modeler 224, volume-based time invariant modeler 226, determiner 222, communicator 230, and other components shown and described. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 924 may further be transmitted or received over a communications network 926 using a transmission medium via the network interface device 920. The machine 900 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. In some examples, the network interface device 920 may wirelessly communicate using Multiple User MIMO techniques.

### OTHER NOTES AND EXAMPLES

Example 1 is a computer implemented method for anomalous event handling, the method comprising: at a first computing device and using at least one hardware processor: receiving a set of data packets originating from a plurality of distributed computing devices, the data packets comprising unstructured data; classifying respective data packets of the set into a plurality of categories based on content of the unstructured data of the respective data packets; determining a count of the number of data packets classified into a first category of the plurality of data categories; calculating a probability that the first category would contain the determined count of the number of data packets using a time invariant Poisson distribution model and a central tendency of the number of data packets in the first category for past time frames; determining that the first category is anomalous based upon the probability; and communicating a category status indication to a second computing device indicating that the first category is anomalous.

In Example 2, the subject matter of Example 1 includes, determining a proportion of the first category with respect to the remaining categories of the plurality of categories; determining a second probability that the first category would account for the determined proportion of all categories based upon a cross-category proportionality model; and wherein determining that the first category is anomalous based upon the probability of occurrence comprises determining, for the first category in the plurality of categories, that the category is anomalous based upon both the probability and second probability.

In Example 3, the subject matter of Example 2 includes, wherein the cross-category proportionality model includes a Gaussian distribution.

In Example 4, the subject matter of Examples 1-3 includes, wherein the unstructured data is application feedback data and the first category is indicative of a potential application defect.

In Example 5, the subject matter of Examples 1-4 includes, wherein the unstructured data is packet data and the first category is indicative of a network problem.

In Example 6, the subject matter of Examples 1-5 includes, wherein the unstructured data is a microblogging posting and the first category is indicative of a trending topic.

In Example 7, the subject matter of Examples 1-6 includes, wherein the unstructured data is sensor data from an Internet of Things computing device and the first category is indicative of a sensor anomaly.

In Example 8, the subject matter of Examples 1-7 includes, wherein communicating an indication to the second computing device that the first category is anomalous comprises communicating the indication in one of: a Voice over Internet Protocol (VoIP) session, an instant messaging communication session, an electronic mail message, or a webpage.

Example 9 is a computing device for anomalous event handling, the computing device comprising: a hardware processor; a memory, comprising instructions, which when executed by the hardware processor, cause the hardware processor to perform operations comprising: receiving a set of data packets originating from a plurality of distributed computing devices, the data packets comprising unstructured data; classifying respective data packets of the set into a plurality of categories based on content of the unstructured data of the respective data packets; determining a count of the number of data packets classified into a first category of the plurality of data categories; calculating a probability that the first category would contain the determined count of the number of data packets using a time invariant Poisson distribution model and a central tendency of the number of data packets in the first category for past time frames; determining that the first category is anomalous based upon the probability; and communicating a category status indication to a second computing device indicating that the first category is anomalous.

In Example 10, the subject matter of Example 9 includes, wherein the operations further comprise: determining a proportion of the first category with respect to the remaining categories of the plurality of categories; determining a second probability that the first category would account for the determined proportion of all categories based upon a cross-category proportionality model; and wherein determining that the first category is anomalous based upon the probability of occurrence comprises determining, for the first category in the plurality of categories, that the category is anomalous based upon both the probability and second probability.

In Example 11, the subject matter of Example 10 includes, wherein the cross-category proportionality model includes a Gaussian distribution.

In Example 12, the subject matter of Examples 9-11 includes, wherein the unstructured data is application feedback data and the first category is indicative of a potential application defect.

In Example 13, the subject matter of Examples 9-12 includes, wherein the unstructured data is packet data and the first category is indicative of a network problem.

In Example 14, the subject matter of Examples 9-13 includes, wherein the unstructured data is a microblogging posting and the first category is indicative of a trending topic.

In Example 15, the subject matter of Examples 9-14 includes, wherein the unstructured data is sensor data from an Internet of Things computing device and the first category is indicative of a sensor anomaly.

In Example 16, the subject matter of Examples 9-15 includes, wherein the operations of communicating an indication to the second computing device that the first category is anomalous comprises communicating the indication in one of: a Voice over Internet Protocol (VoIP) session, an instant messaging communication session, an electronic mail message, or a webpage.

Example 17 is a machine-readable medium, comprising instructions for anomalous event handling, the instructions when executed by the machine, cause the machine to perform operations comprising: receiving a set of data packets originating from a plurality of distributed computing devices, the data packets comprising unstructured data; classifying respective data packets of the set into a plurality of categories based on content of the unstructured data of the respective data packets; determining a count of the number of data packets classified into a first category of the plurality of data categories; calculating a probability that the first category would contain the determined count of the number of data packets using a time invariant Poisson distribution model and a central tendency of the number of data packets in the first category for past time frames; determining that the first category is anomalous based upon the probability; and communicating a category status indication to a second computing device indicating that the first category is anomalous.

In Example 18, the subject matter of Example 17 includes, wherein the operations further comprise: determining a proportion of the first category with respect to the remaining categories of the plurality of categories; determining a second probability that the first category would account for the determined proportion of all categories based upon a cross-category proportionality model; and wherein determining that the first category is anomalous based upon the probability of occurrence comprises determining, for the first category in the plurality of categories, that the category is anomalous based upon both the probability and second probability.

In Example 19, the subject matter of Example 18 includes, wherein the cross-category proportionality model includes a Gaussian distribution.

In Example 20, the subject matter of Examples 17-19 includes, wherein the unstructured data is application feedback data and the first category is indicative of a potential application defect.

In Example 21, the subject matter of Examples 17-20 includes, wherein the unstructured data is packet data and the first category is indicative of a network problem.

In Example 22, the subject matter of Examples 17-21 includes, wherein the unstructured data is a microblogging posting and the first category is indicative of a trending topic.

In Example 23, the subject matter of Examples 17-22 includes, wherein the unstructured data is sensor data from an Internet of Things computing device and the first category is indicative of a sensor anomaly.

In Example 24, the subject matter of Examples 17-23 includes, wherein the operations of communicating an indication to the second computing device that the first category is anomalous comprises communicating the indication in one of: a Voice over Internet Protocol (VoIP) session, an instant messaging communication session, an electronic mail message, or a webpage.

Example 25 is a computing device for anomalous event handling, the computing device comprising: means for receiving a set of data packets originating from a plurality of distributed computing devices, the data packets comprising unstructured data; means for classifying respective data packets of the set into a plurality of categories based on content of the unstructured data of the respective data packets; means for determining a count of the number of data packets classified into a first category of the plurality of data categories; means for calculating a probability that the first category would contain the determined count of the number of data packets using a time invariant Poisson distribution model and a central tendency of the number of data packets in the first category for past time frames; means for determining that the first category is anomalous based upon the probability; and means for communicating a category status indication to a second computing device indicating that the first category is anomalous.

In Example 26, the subject matter of Example 25 includes, means for determining a proportion of the first category with respect to the remaining categories of the plurality of categories; means for determining a second probability that the first category would account for the determined proportion of all categories based upon a cross-category proportionality model; and wherein the means for determining that the first category is anomalous based upon the probability of occurrence comprises means for determining, for the first category in the plurality of categories, that the category is anomalous based upon both the probability and second probability.

In Example 27, the subject matter of Example 26 includes, wherein the cross-category proportionality model includes a Gaussian distribution.

In Example 28, the subject matter of Examples 25-27 includes, wherein the unstructured data is application feedback data and the first category is indicative of a potential application defect.

In Example 29, the subject matter of Examples 25-28 includes, wherein the unstructured data is packet data and the first category is indicative of a network problem.

In Example 30, the subject matter of Examples 25-29 includes, wherein the unstructured data is a microblogging posting and the first category is indicative of a trending topic.

In Example 31, the subject matter of Examples 25-30 includes, wherein the unstructured data is sensor data from an Internet of Things computing device and the first category is indicative of a sensor anomaly.

In Example 32, the subject matter of Examples 25-31 includes, wherein the means for communicating an indication to the second computing device that the first category is anomalous comprises means for communicating the indication in one of: a Voice over Internet Protocol (VoIP) session, an instant messaging communication session, an electronic mail message, or a webpage.

Example 33 is at least one machine-readable medium including instructions that, when executed by processing circuitry, cause the processing circuitry to perform operations to implement of any of Examples 1-32.

Example 34 is an apparatus comprising means to implement of any of Examples 1-32.

Example 35 is a system to implement of any of Examples 1-32.

Example 36 is a method to implement of any of Examples 1-32.

What is claimed is:

1. A computer implemented method for anomalous event handling, the method comprising:
at a first computing device and using at least one hardware processor:
receiving a set of data packets originating from a plurality of distributed computing devices, the data packets comprising unstructured data;
classifying respective data packets of the set into a plurality of categories based on content of the unstructured data of the respective data packets;
determining a count of the number of data packets classified into a first category of the plurality of data categories;
calculating a probability that the first category would contain the determined count of the number of data packets using a time invariant Poisson distribution model and a central tendency of the number of data packets in the first category for past time frames;
determining that the first category is anomalous based upon the probability; and
communicating a category status indication to a second computing device indicating that the first category is anomalous.

2. The method of claim 1, comprising:
determining a proportion of the first category with respect to the remaining categories of the plurality of categories;
determining a second probability that the first category would account for the determined proportion of all categories based upon a cross-category proportionality model; and
wherein determining that the first category is anomalous based upon the probability of occurrence comprises determining, for the first category in the plurality of categories, that the category is anomalous based upon both the probability and second probability.

3. The method of claim 2, wherein the cross-category proportionality model includes a Gaussian distribution.

4. The method of claim 1, wherein the unstructured data is application feedback data and the first category is indicative of a potential application defect.

5. The method of claim 1, wherein the unstructured data is packet data and the first category is indicative of a network problem.

6. The method of claim 1, wherein the unstructured data is a microblogging posting and the first category is indicative of a trending topic.

7. The method of claim 1, wherein the unstructured data is sensor data from an Internet of Things computing device and the first category is indicative of a sensor anomaly.

8. The method of claim 1, wherein communicating an indication to the second computing device that the first category is anomalous comprises communicating the indication in one of: a Voice over Internet Protocol (VoIP) session, an instant messaging communication session, an electronic mail message, or a webpage.

9. A computing device for anomalous event handling, the computing device comprising:
a hardware processor;
a memory, comprising instructions, which when executed by the hardware processor, cause the hardware processor to perform operations comprising:
receiving a set of data packets originating from a plurality of distributed computing devices, the data packets comprising unstructured data;
classifying respective data packets of the set into a plurality of categories based on content of the unstructured data of the respective data packets;
determining a count of the number of data packets classified into a first category of the plurality of data categories;
calculating a probability that the first category would contain the determined count of the number of data packets using a time invariant Poisson distribution model and a central tendency of the number of data packets in the first category for past time frames;
determining that the first category is anomalous based upon the probability; and
communicating a category status indication to a second computing device indicating that the first category is anomalous.

10. The computing device of claim 9, wherein the operations further comprise:
determining a proportion of the first category with respect to the remaining categories of the plurality of categories;
determining a second probability that the first category would account for the determined proportion of all categories based upon a cross-category proportionality model; and
wherein determining that the first category is anomalous based upon the probability of occurrence comprises determining, for the first category in the plurality of categories, that the category is anomalous based upon both the probability and second probability.

11. The computing device of claim 10, wherein the cross-category proportionality model includes a Gaussian distribution.

12. The computing device of claim 9, wherein the unstructured data is application feedback data and the first category is indicative of a potential application defect.

13. The computing device of claim 9, wherein the unstructured data is packet data and the first category is indicative of a network problem.

14. The computing device of claim 9, wherein the unstructured data is a microblogging posting and the first category is indicative of a trending topic.

15. The computing device of claim 9, wherein the unstructured data is sensor data from an Internet of Things computing device and the first category is indicative of a sensor anomaly.

16. The computing device of claim 9, wherein the operations of communicating an indication to the second computing device that the first category is anomalous comprises communicating the indication in one of: a Voice over Internet Protocol (VoIP) session, an instant messaging communication session, an electronic mail message, or a webpage.

17. A computing device for anomalous event handling, the computing device comprising:
means for receiving a set of data packets originating from a plurality of distributed computing devices, the data packets comprising unstructured data;
means for classifying respective data packets of the set into a plurality of categories based on content of the unstructured data of the respective data packets;
means for determining a count of the number of data packets classified into a first category of the plurality of data categories;
means for calculating a probability that the first category would contain the determined count of the number of data packets using a time invariant Poisson distribution model and a central tendency of the number of data packets in the first category for past time frames;
means for determining that the first category is anomalous based upon the probability; and
means for communicating a category status indication to a second computing device indicating that the first category is anomalous.

18. The computing device of claim 17, comprising:
means for determining a proportion of the first category with respect to the remaining categories of the plurality of categories;
means for determining a second probability that the first category would account for the determined proportion of all categories based upon a cross-category proportionality model; and
wherein the means for determining that the first category is anomalous based upon the probability of occurrence comprises means for determining, for the first category in the plurality of categories, that the category is anomalous based upon both the probability and second probability.

19. The computing device of claim 18, wherein the cross-category proportionality model includes a Gaussian distribution.

20. The computing device of claim 17, wherein the means for communicating an indication to the second computing device that the first category is anomalous comprises means for communicating the indication in one of: a Voice over Internet Protocol (VoIP) session, an instant messaging communication session, an electronic mail message, or a webpage.
